(19) United States
(12) Patent Application Publication
(10) Pub. No.: US 2008/0312018 A1
(43) Pub. Date: Dec. 18, 2008

(54) Power transmission and hub used for power transmission

(75) Inventors: Yoshihiro Nakata, Kariya-city (JP); Yasuo Tabuchi, Kariya-city (JP); Keiji Ishikawa, Okazaki-city (JP); Takayuki Suzuki, Hekinan-city (JP); Michiyasu Nosaka, Anjyo-city (JP); Yoshiki Tada, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/155,848

(22) Filed: Jun. 10, 2008

(30) Foreign Application Priority Data
Jun. 12, 2007 (JP) 2007-155516

(51) Int. Cl. F16H 55/06

(52) U.S. Cl. 474/161

(57) ABSTRACT

In a power transmission 1 in which a pulley 2 and a hub 5 are engaged with each other, in protrusions 51 of the hub 5 side and in protrusions 22 of the pulley 2 side located on an outer circumferential side with respect to an outer hub 53, an annular dust flange 51d is provided which protrudes and expands to the outside in the radial direction from a front side portion which adjoins protrusions 51c of an elastic portion 52. When an outer circumferential end of this dust flange 51d is elastically, tightly contacted with a sealing portion 23 of the pulley 2, a front face of the protrusions 22 can be completely covered.

### BACKGROUND OF THE INVENTION

1. Technical Field of the Invention

The present invention relates to a power transmission in which a hub and a pulley are dynamically connected to each other so as to transmit power. The present invention also relates to a hub used for the power transmission.

2. Description of the Related Art

A power transmission for transmitting power of a drive source to a compressor which is a device to be driven, a conventional power transmission is known in which a hub having a damping mechanism made of rubber and a pulley are provided and recess portions are provided in the pulley, and protrusions formed of elastic members and engaged with the recess portions are formed on the hub side, so that both the recess portions and the protrusions can be engaged with each other in the axial direction.

In the case where the engaging portion, in which the recess portions of the pulley and the protrusions of the hub are engaged with each other, is exposed on the front face (the front side) of the pulley, foreign objects such as dust and water, which affect the elastic member of the hub, enter the engaging portion of the hub and the pulley from the outside, which causes abnormal wear of the engaging portion, in which the recess portions of the pulley and the protrusions of the hub are engaged with each other.

Therefore, in the case of the power transmission described in the official gazette of JP-A-2006-220166, (foreign objects such as dust and water are prevented from entering the engaging portion), in which the hub and the pulley are engaged with each other, by a thin portion bridging a gap between the protrusions which are adjacent to each other, providing in the protrusions of the hub and a front face of the engaging portion of the hub and the pulley covered by the thin portion concerned.

However, the thin portion, which is provided in the power transmission described in the official gazette of JP-A-2006-220166, only bridges a gap between the protrusions adjacent to each other. Therefore, in the case where the recess portions of the pulley are larger in the radial direction than the protrusions of the hub, it is impossible for the thin portion to completely cover the engaging portion in which the recess portions of the pulley and the protrusions of the hub are engaged with each other. Therefore, it is necessary to individually design the size of the hub in accordance with the diameter of the pulley.

### SUMMARY OF THE INVENTION

The present invention has been proposed to improve the above problems. An object of the present invention is to provide a power transmission in which it is possible to cover a front face of the engaging portion in which the recess portions of the pulley and the protrusions of the hub are engaged with each other even in the case where the recess portions of the pulley are larger in the radial direction than the protrusions of the hub in size. Another object of the present invention is to provide a hub used for the power transmission.

In order to solve the above problems, the invention described in claim 1 provides a power transmission (1) for transmitting power from a pulley (2), which is connected to a drive source, to a rotary shaft (3) of a device to be driven, wherein the pulley (2) includes recess portions (21), the hub (5) includes protrusions (51c) engaged with the recess portions (21), and the hub (5) also includes a dust flange (51d) for sealing a gap formed between the hub (5) and the pulley (2) when the dust flange (51d) is arranged being extended to the outside of the protrusions (51c) in the radial direction and the dust flange (51d) is contacted with and deformed by an edge portion of the pulley (2).

Due to the foregoing, it is possible to prevent foreign objects such as dust and water from entering the recess portions (21), and, it is also possible to prevent the occurrence of abnormal wear between the hub (5) and the pulley (2).

According to the invention described in claim 2, the hub (5) includes an inner hub (51), an elastic portion (52) and an outer hub (53), the outer hub (53) extends and surrounds the elastic portion (52) and has the protrusions (51c) on its outer circumferential face, and the protrusions (51c) are provided being integrated with the dust flange (51d).

As long as the dust flange (51d) on the outer circumference of the outer hub (53) can contact the inside of the pulley (2) under the condition that the dust flange (51d) is elastically deformed at the time of engaging the hub (5) with the pulley (2), even the hub (5), which is not suitable for the pulley (2), can be used for the pulley (2).

In the invention described in claim 3, an edge portion of the pulley (2) is chamfered or formed into an R-shape.

Due to the foregoing, even when a size of the protrusions (22) of the pulley (2) side is close to those of the protrusions (51c) of the hub (5) side, the dust flange (51d) is deformed being folded onto the front side. While the dust flange (51d) is deformed and contacts an edge portion of the pulley (2), the pulley (2) and the hub (5).are engaged with each other.

Since the dust flange (51d) can be tightly contacted with an edge portion of the pulley (2), the sealing property can be enhanced and it is possible to completely prevent foreign objects such as dust and water from entering between the pulley (2) and the hub (5).

According to the invention described in claim 4, cutout portions (54) to be contacted with the protrusions (22) of the pulley (2) side are formed in the recess portions (21) in the circumferential direction at predetermined intervals.

Due to the foregoing, it is possible to engage the hub (5) with the pulley (2) without shaking.

In the invention described in claim 5, a hub (5) used for a power transmission of transmitting power from a pulley (2), which is connected to a drive source, to a rotary shaft (3) of a device to be driven, comprises: a connecting portion (4) capable of being connected to the rotary shaft (3) so that the connecting portion (4) can be integrally rotated together with the rotary shaft (3); protrusions (51c) protruding toward the pulley (2) side and engaging with the recess portions (21) provided in the pulley (2); and a dust flange (51d) for sealing a gap formed between the hub (5) and the pulley (2) when the dust flange (51d) is arranged being extended to the outside of the protrusions (51c) in the radial direction and the dust flange (51d) is contacted with and deformed by an edge portion of the pulley (2).

Due to the foregoing, even in the case where the recess portions (21) of the pulley (2) are larger in the radial direction than the protrusions (51c) of the hub (5) side in size, as long as the dust flange (51d) can be contacted with an edge portion of the pulley (2) and deformed, the hub (5) can cover a front face of the engaging portion of the pulley (2).

Reference marks in parentheses attached to the means described above, represent the corresponding specific means described in the embodiment described later.

The present invention may be more fully understood from the description of preferred embodiments of the invention, as set forth below, together with the accompanying drawings.

### BRIEF DESCRIPTION OF THE DRAWINGS

In the drawings:

FIG. 1 is a view showing an upper half of the longitudinal cross-section of the power transmission of the first embodiment of the present invention;

FIG. 2 is an enlarged view showing a primary portion of FIG. 1;

FIG. 3 is an upper half front view showing a power transmission of the first embodiment of the present invention;

FIG. 4 is a view showing an upper half of the longitudinal cross-section of the power transmission of the second embodiment of the present invention; and

FIG. 5 is an enlarged view showing a primary portion of FIG. 4.

### DESCRIPTION OF THE INVENTION

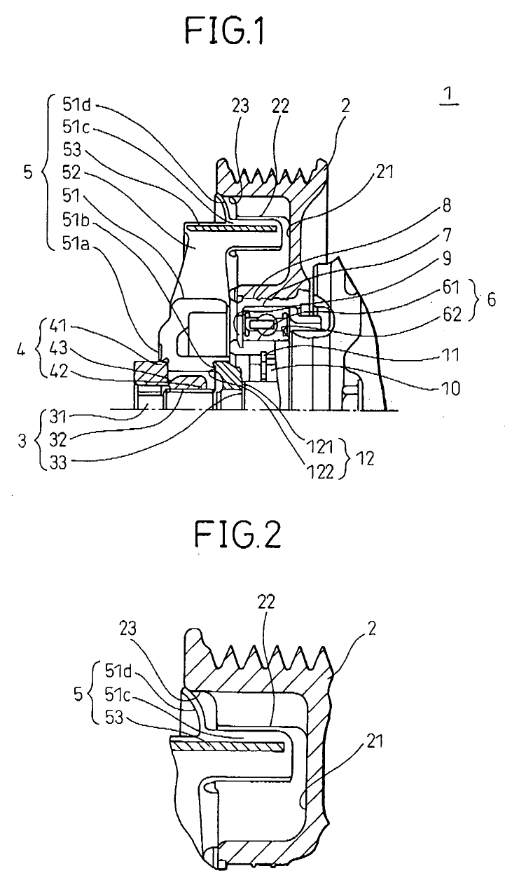

FIG. 1 is a view showing an upper half of the longitudinal cross-section of the power transmission 1 of the present invention.

In this power transmission 1, power is transmitted from the pulley 2, which is dynamically connected to a drive source, to the rotary shaft 3 of a compressor, which is a device to be driven, through the hub 5 and the connecting portion 4 which will be referred to as a torque limiter 4 hereinafter. Pulley 2 and hub 5 are arranged on the same axis. In this connection, the present invention cannot only be applied to the power transmission 1 in which the torque limiter 4, which is a connecting portion, is provided, but also can be applied to the power transmission 1 in which the hub 5 is directly fixed to the rotary shaft 3.

The pulley 2 is pivotally attached to the cylindrical boss portion 61, which is arranged on one end side of the casing 6 of a compressor, through the bearing 7 and the ring 8.

It is preferable that pulley 2 be molded of thermoplastic resin material. The pulley 2 may be made of metallic material. In the case where the pulley 2 is made of resin, it is normal for the pulley 2, the ring 8 and the bearing 7 are integrated with each other into one body by means of insert molding. A belt (not shown in the drawing) is wound round an outer circumference of the pulley 2. Therefore, the pulley 2 is rotated by power given from an external device such as an engine or a motor.

The bearing 7 is engaged in the boss portion 61 and its movement in the axial direction is prevented by the end portion 62 of the boss portion 61 and also prevented by the first snap ring 9 fitted into a groove formed on the outer circumferential face of the boss portion 61. The casing 6 and the rotary shaft 3 are tightly sealed by the shaft sealing device 10, so that refrigerant and oil can be prevented from leaking outside. Further, a movement of the shaft sealing device 10 in the axial direction is prevented by the second snap ring 11 fitted into a groove formed on the inner circumferential face of the boss portion 61.

A forward end portion of the rotary shaft 3 of a compressor protrudes from the casing 6. The forward end portion of the rotary shaft 3 includes: a tool-shaped portion 31, the shape of which is formed into a tool-shape; a screw portion, on the outer circumference of which a screw is formed; and a large diameter portion, the diameter of which is larger than that of the screw portion 32, wherein these components are arranged from the forward end portion of the rotary shaft in this order. Between the screw portion 32 and the large diameter portion, the step portion 33 is formed. Into the forward end portion of the rotary shaft 3, the washer 12 is inserted. The end portion A121 of the washer 12 comes into contact with the step portion 33. The torque limiter 4 described later is fixed to the screw portion 32 of the rotary shaft 3. In this connection, concerning the method of fixing the torque limiter 4 to the rotary shaft 3, not only the method of screwing, but also the other fixing methods such as a method of spline engagement and a method of attaching with bolts can be appropriately employed.

The torque limiter 4, which is the connecting portion, includes: a large outer diameter portion, the shape of which is a square cylinder or a circular cylinder; and a small outer diameter portion, the shape of which is a square cylinder or a circular cylinder. An outer circumferential face of the large outer diameter portion is an engagement portion 41 engaging with the hub 5 described later. On an inner circumferential face of the small outer diameter portion, the screw portion 42 is formed and joined to the screw portion 32 of the rotary shaft 3 by means of screwing. The inner diameter of the large outer diameter portion is a little larger than an inner diameter of the small outer diameter portion. In a transition portion between the inner circumferential faces, the cutout portion 43 is formed. When the torque limiter is given an excessively strong axial force, it is easily broken.

The hub 5 includes an inner hub 51, an elastic port ion 52 and an outer hub 53.

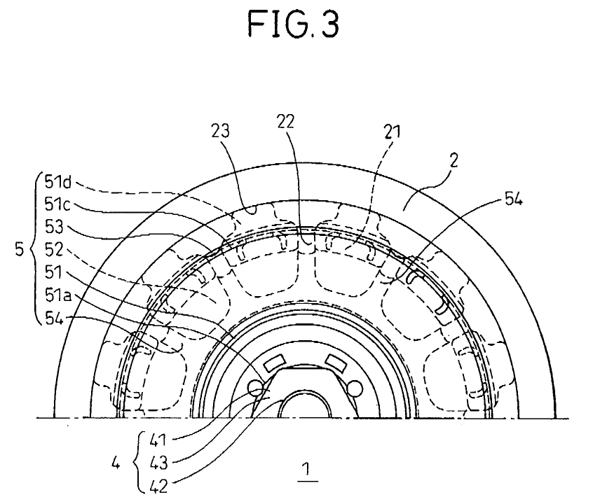

The inner circumferential face 51a of the inner hub 51 is formed into a shape substantially fitted to the outer circumferential face of the torque limiter 4. Therefore, the engagement portion 51a engaged to the outer circumferential face (the engaging portion) 41 of the large outer diameter portion of the torque limiter 4 is provided. In the present embodiment, as shown in FIG. 3, the engaging portion 51a of the hub 5 is circular and the engaging portion 41 of the torque limiter 4 is formed into a hexagonal shape inscribed with the engaging portion 51a of the hub 5.

As described above, the hub 5 and the torque limiter 4 are fixed to each other by means of engagement. When the rear side end face 51b of the hub 5 comes into contact with the end portion B122 of the washer 12, the hub 5 is held being interposed between the torque limiter 4 and the washer 12. An outer circumferential face of the inner hub 51 is joined to the elastic portion 52 by means of adhesion.

The outer hub 53 is formed into a cylindrical shape and made of metallic material in the same manner as that of the inner hub 51.

The elastic portion 52 is made of elastic material such as rubber or resin and arranged between the inner hub 51 and the outer hub 53. The elastic portion 52 is joined onto an outer circumferential face of the inner hub 51 and an inner circumferential face of the outer hub 53 by means of adhesion. Alternatively, these three components may be integrated with each other onto one body by means of insertion molding. This elastic portion 52 functions not only as a member for the transmission of torque, but also as a toque damper.

The outer hub 53 is arranged extended and surrounded by the elastic portion 52. On the surfaces in three directions (the outer circumferential face) of the upper face, the side face and the lower face, the protrusions 51c are provided.

As shown in FIG. 3, in the protrusions 51c, the cutout portions 54, which come into contact with the recess portions (described later) on the pulley 2 side, are formed at predetermined intervals in the circumferential direction. These cutout portions 54 are provided so that they can be made to correspond to reinforcing portions (reinforcing ribs) provided on the pulley side.

In the outer hub 53, the dust flange 51d, the cross section of which is a lip-shape coming into contact with a sealing portion of the pulley 2 described later without leaving any gap, is integrally formed in the protrusions 51c surrounding the elastic portion 52.

In this connection, in the structure explained above, the hub 5 includes three components of the inner hub 51, the elastic portion 52 and the outer hub 53. However, the outer hub 53 may be omitted and the hub 5 may include two components of the inner hub 51 and the elastic portion 52.

On the other hand, on an end face on the front side of the pulley 2, the annular recess portions 21 are formed which receive the protrusions 51c of the hub 5.

In the pulley 2, the protrusions 22 are provided which are engaged with the cutout portions 54 formed in the protrusions 51c on the hub side in the circumferential direction at predetermined intervals.

Due to the above structure, when the protrusions 51c are inserted into the recess portions 21 of the pulley 2, the hub 5 and the pulley 2 are joined to each other.

Since a surface side of the pulley 2, on which the protrusions 22 are formed, is exposed outside, foreign objects such as dust and water tend to enter the surface side.

Therefore, in order to prevent the protrusions 22 from being exposed to the outside, the dust flange 51d, which seals the protrusions 22 when it is pushed toward the protrusions 22 from the surface side on which the protrusions 22 of the pulley 2 are formed, is provided in the protrusions 51c of the elastic portion 52 on the hub 5 side so that the dust flange 51d can be arranged being extended from the protrusions 51c to the outside in the radial direction.

This dust flange 51d is formed integrated with the elastic portion 52 into one body. By an elastic force of the elastic portion 52, an outer circumferential end of the dust flange 51d is elastically contacted with and deformed by the sealing portion 23 on the surface side, which is an edge portion of the pulley 2, on which the protrusions 22 of the pulley 2 are formed when a gap between the hub 5 and the pulley 2 is sealed by the dust flange 51d in this way, a front face of the protrusions 22 can be completely covered.

In this connection, the sealing portion 23, which is an edge portion of the pulley 2, is chamfered and formed into an R-shape.

Since the power transmission 1 of the present invention is composed as described above, when the protrusions 51c on the hub 5 side are inserted into the recess portions 21 on the pulley 2 side, the hub 5 and the pulley 2 are joined to each other.

In this case, the annular dust flange 51d is provided which protrudes from the front side portion adjoining the protrusions 51c of the elastic portion 52 to the outside of the protrusions 51c in the radial direction. Therefore, an outer circumferential end of this dust flange 51d is elastically contacted with and deformed by the sealing portion 23 on the surface side which is an edge portion of the pulley 2, so that a gap between the hub 5 and the pulley 2 can be sealed.

At this time, since the sealing portion 23, which is an edge portion of the pulley 2, is chamfered and formed into an R-shape, an outer circumferential end of the dust flange 51d can be tightly contacted with the sealing portion 23. Since the sealing property is enhanced and the front face of the engaging portion, in which the protrusions and the recess portions are engaged with each other, can be completely covered, foreign objects such as dust and water can be prevented from entering the protrusions 22. Accordingly, the occurrence of abnormal wear of this portion can be prevented.

As described above, when the hub 5 and the pulley 2 are joined to each other, the dust flange 51d is tightly contacted with the sealing portion 23 and capable of preventing foreign objects such as dust and water from entering the protrusions 22. In other words, even when the hub 5 and the pulley 2 are not fitted to each other in size, as long as it is in a range in which the dust flange 51d is deformed and elastically contacted with the sealing portion 23 of the pulley 2, even if outer diameters of the pulley 2 and the hub 5 do not agree with each other, it is possible for the dust flange 51d to seal an outer circumference of the hub 5. Therefore, it becomes unnecessary to design the individual hubs so as to make the diameters agree with each other. Accordingly, the designing cost of designing the hub can be reduced.

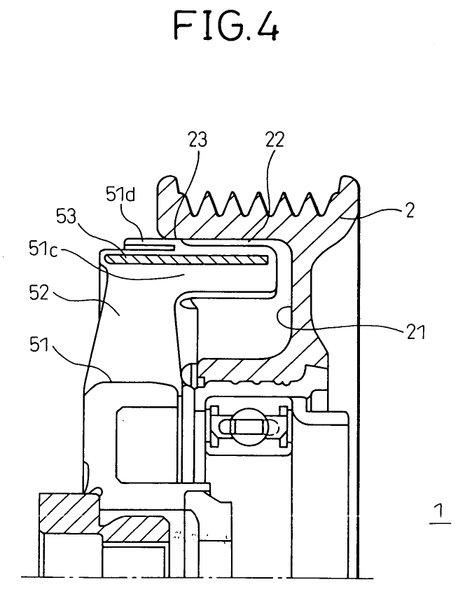

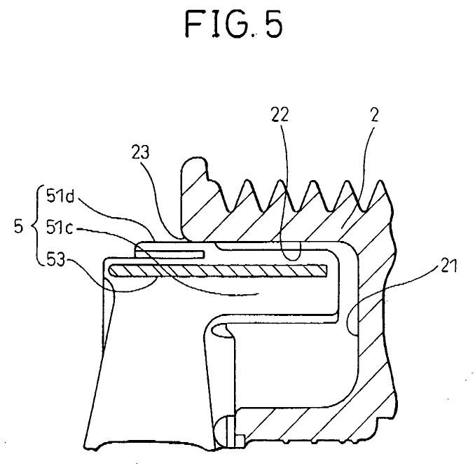

An example is shown in FIG. 4 in which the hub 5 used for the above embodiment is applied to a pulley 2 of another dimensional standard.

As shown in the drawing, the pulley 2 is smaller than the pulley 2 of the power transmission 1 of the above embodiment in size.

The substantial constituent components of the power transmission 1 of this case are the same as those of the power transmission 1 described before. Therefore, the duplicate explanations are omitted here.

In the power transmission 1 of this case, when the hub 2 and the pulley 2 are joined to each other, an inner diameter of the pulley 2 is smaller than that of the pulley 2 of the above power transmission 1 in size. Therefore, it can be understood that the dust flange 51d is tightly contacted with the sealing portion 23 of the pulley 2 being compressed.

As described above, the dust flange 51d is elastically, tightly contacted with the sealing portion 23 of the pulley 2. Therefore, the sealing property can be ensured and a front face of the protrusions 22 can be completely covered. Accordingly, it is possible to prevent foreign objects such as dust and water from entering the protrusions 22.

In this connection, the power transmission is explained above in which the hub 5 is fixed to the rotary shaft 3 through the torque transmitter 4. However, the dust invasion preventing section of the present invention can be applied to a power transmission composed in such a manner that the torque limiter is provided on the rotary shaft and the hub is directly fixed to the rotary shaft.

While the invention has been described by reference to specific embodiments chosen for purpose of illustration, it should be apparent, to those skilled in the art, that numerous modifications could be made thereto without departing from the basic concept and scope of the invention.

1. A power transmission for transmitting power from a pulley, which is dynamically connected to a drive source, to a rotary shaft of a device to be driven, wherein
the pulley includes recess portions,
the hub includes protrusions engaged with the recess portions, and
the hub also includes a dust flange for sealing a gap formed between the hub and the pulley when the dust flange is arranged being extended to the outside of the protrusions in the radial direction and the dust flange is contacted with and deformed by an edge portion of the pulley.

2. A power transmission according to claim 1, wherein the hub includes an inner hub, an elastic portion and an outer hub,
the outer hub extends and surrounds the elastic portion and has the protrusions on its outer circumferential face, and
the protrusions are provided being integrated with the dust flange.

3. A power transmission according to claim 1, wherein an edge portion of the pulley is chamfered or formed into an R-shape.

4. A power transmission according to claim 1, wherein cutout portions to be contacted with the protrusions on the pulley side are formed in the recess portions in the circumferential direction at predetermined intervals.

5. A hub used for a power transmission of transmitting power from a pulley, which is dynamically connected to a drive source, to a rotary shaft of a device to be driven, comprising:
a connecting portion capable of being connected to the rotary shaft so that the connecting portion can be integrally rotated together with the rotary shaft;
protrusions protruding toward the pulley side and engaging with the recess portions provided in the pulley; and
a dust flange for sealing a gap formed between the hub and the pulley when the dust flange is arranged being extended to the outside of the protrusions in the radial direction and the dust flange is contacted with and deformed by an edge portion of the pulley.
